(19) United States
(12) Patent Application Publication
(10) Pub. No.: US 2012/0054999 A1
(43) Pub. Date: Mar. 8, 2012

(54) METHOD OF FABRICATING SLEEVES FOR TRAMPOLINES

(76) Inventor: Hua-Lu Hsiang, Taoyuan City (TW)

(21) Appl. No.: 12/876,734

(22) Filed: Sep. 7, 2010

(51) Int. Cl. B23P 17/04

(52) U.S. Cl. 29/428

(57) ABSTRACT

A method of fabricating sleeves for trampolines includes steps of: first, bending a plate into a tube with a coupling seam bonded through a bonding process to form a sleeve; next, expanding an opening of the sleeve through an opening expansion means to form a body and an expanded opening section extended from the body; applying a compressive force to the expanded opening section to form an outer expanded portion and an inner folding portion. When the sleeve is coupled with a connection tube, the outer expanded portion and inner folding portion provide greater structural strength. Whether defects are formed on the coupling seam at the outer expanded portion and inner folding portion can be easily and visually detected after the fabrication process is finished. Thus defected sleeve can be instantly identified during the fabrication process to save extra inspection time. Fabrication productivity of trampolines also improves.

### FIELD OF THE INVENTION

The present invention relates to a fabrication method and particularly to a fabrication method capable of detecting fabrication defects of sleeves for trampolines.

### BACKGROUND OF THE INVENTION

Trampoline is a jumping sport equipment allowing users to jump in the air to perform various movements to do exercise on leg muscles, enhance bouncing capability and improve coordination. Besides used on general sport activities, it is also frequently used in circus or acrobatics to allow performers to do special movements in the air to entertain audiences.

U.S. patent Nos. 2004/0176214, 2006/0172861 and 2007/0012902 disclose trampolines that include a frame to hold a jumping net. The frame consists of a plurality of tubes coupling together in a compact manner. The tubes usually are fabricated by machining a tube close to an opening in a conical shape at a reduced outer diameter or in a cylindrical shape at an outer diameter smaller than the tube so that mutual coupling can be accomplished between them. The tube generally is made of metal and can be formed integrally such as by casting, injection or machining. It also can be fabricated from a metal plate by forming and bonding. The tube made integrally generally is more expensive, but is cheaper if fabricated from the metal plate, thus the metal plate is commonly adopted to reduce production cost.

Please refer to FIG. 1 for a conventional trampoline with a frame comprising a plurality of first tubes 1 and second tubes 2 coupled together. Also refer to FIGS. 2A and 2B for coupling of the first tube 1 and second tube 2 of the conventional frame of a trampoline. The first tube 1 and second tube 2 are fabricated by soldering with a solder seam 3 and 4 formed respectively thereon to be coupled with each other. The second tube 2 also has a coupling portion 5 at one end formed by machining. During assembly, the coupling portion 5 is inserted into the opening of the first tube 1 and a pressure is applied on the opening to form a compact coupling between the first and second tubes 1 and 2. The solder seams 3 and 4 have a vertical coupling interface that generates a tensile stress and a compressive stress in the compact coupling condition. The tensile stress that the coupling interface generally can bear is much smaller than the compressive stress, hence damage usually takes place on the first tube 1. Thus the coupling interface of the solder seam 3 affects the coupling quality between the first tube 1 and second tube 2.

During assembly of the trampoline, the solder seam 3 has to be inspected whether obvious detects are formed before the first tube 1 and second tube 2 are coupled with each other to avert defective coupling between the first tube 1 and second tube 2. As possible defects on the solder seam 3 are very small and usually cannot be detected by visual inspection, the conventional inspection method is aided by incorporating with inspection equipment to project light on the solder seam 3. By observing through the light penetration, a defect can be identified. However, such a method cannot be applied to mass production if a great number of tubes have to be inspected and significantly reduces assembly efficiency of the trampoline. As a result, production cost is higher.

### SUMMARY OF THE INVENTION

Therefore, the primary object of the present invention is to solve the problem of tube inspection of the conventional trampoline that requires extra equipment to determine coupling quality.

To achieve the foregoing object, the present invention provides a method of fabricating sleeves for trampolines that forms a frame of a trampoline. The method includes the steps as follow:

bending a plate which has a first lateral edge and a second lateral edge that face each other to form a coupling seam which is bonded through a bonding process to form a sleeve;

expanding an opening of the sleeve through an opening expansion means so that the sleeve includes a body and an expanded opening section extended from the body and formed at a diameter greater than that of the body;

applying a compressive force to the expanded opening section to form an outer expanded portion connected to the body and an inner folding portion bending inwards; and

inspecting visually the coupling state of the coupling seam in the outer expanded portion and the inner folding portion to determine whether the first lateral edge and second lateral edge are bonded tightly.

The fabrication method of the sleeves set forth above provides many advantages over the conventional techniques, notably:

1. The outer expanded portion and inner folding portion reinforce structural strength after the sleeves are coupled, and can withstand greater impact of external forces without causing damage on the coupling seam.

2. Defected products caused by defective coupling seam can be visually detected when the compressive force is applied to the expanded opening section without the aid of extra inspection equipment, hence productivity of fabricating the trampoline increases.

3. The method of fabricating sleeves of the invention integrates the fabrication process of sleeves and inspection of the coupling seam so that fabrication and defect inspection of the sleeves can be performed at the same time to reduce process steps of trampoline production.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional trampoline.

FIGS. 2A and 2B are schematic views showing assembly processes for tubes of the conventional trampoline.

FIG. 3 is a flowchart of the method of fabricating sleeves for trampolines of the invention.

FIGS. 4A and 4B are schematic views showing an embodiment of the invention for fabricating a sleeve.

FIGS. 5A and 5B are sectional views showing an embodiment of the invention for fabricating a sleeve.

FIG. 6 is a perspective view of an embodiment of the invention showing a bent sleeve.

FIG. 7 is a perspective view of an embodiment of the invention showing a compressed sleeve.

FIG. 8 is a perspective view of another embodiment of the invention showing a bent sleeve.

FIG. 9 is a schematic view of an embodiment of the invention showing a sleeve and a connection tube in a coupled condition.

FIG. 10 is a schematic view of an embodiment of the invention showing a defect on the coupling seam of a sleeve.

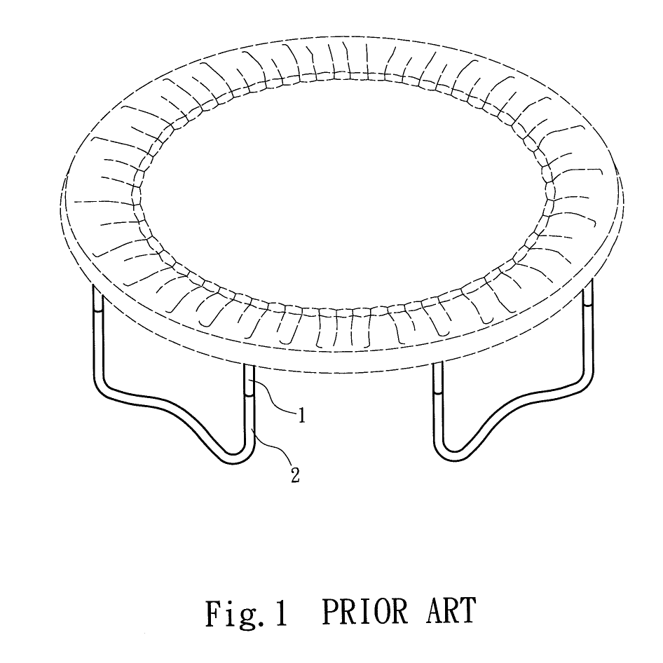

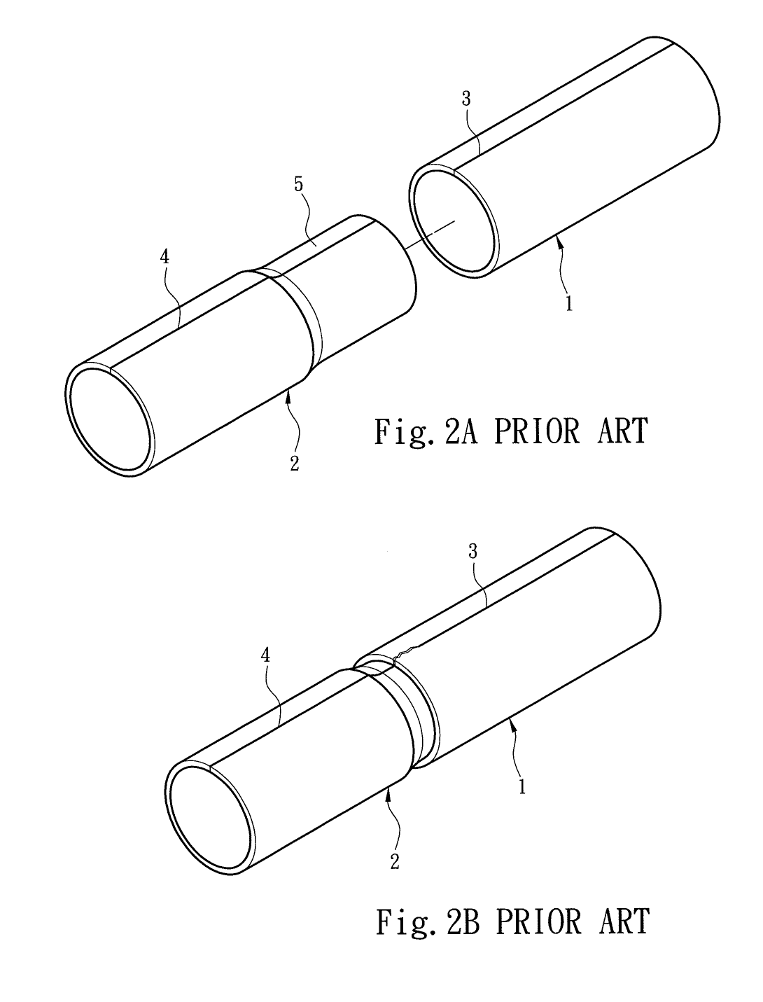

### DETAILED DESCRIPTION OF THE PREFERRED EMBODIMENTS

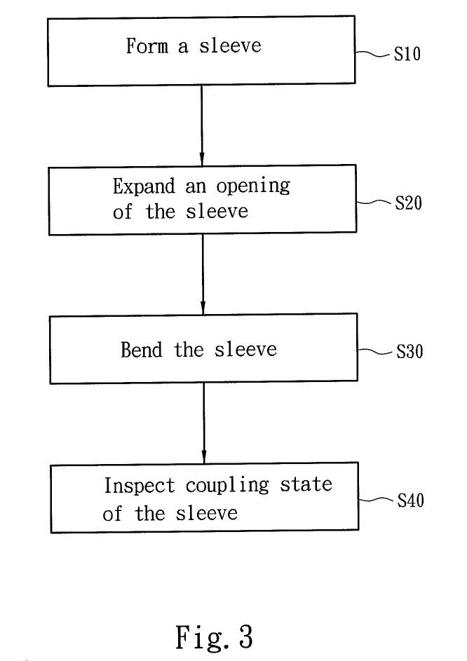

Please refer to FIG. 3, the method of fabricating sleeves for trampolines according to the invention includes the steps as follow:

forming a sleeve (S10) by bending a plate which has a first lateral edge and a second lateral edge that face each other to form a coupling seam, then bonding the coupling seam through a bonding process to form the sleeve;

expanding an opening of the sleeve (S20) through an opening expansion means so that the sleeve includes a body and an expanded opening section extended from the body and formed at a diameter greater than that of the body;

bending the sleeve (S30) by applying a compressive force to the expanded opening section to form an outer expanded portion connected to the body and an inner folding portion bending inwards; and

inspecting the coupling state of the sleeve (S40) through a visual inspection means to inspect the coupling state of the coupling seam in the outer expanded portion and inner folding portion to determine whether the first lateral edge and the second lateral edge are bonded tightly.

The fabrication method previously discussed is further elaborated through embodiments as follow:

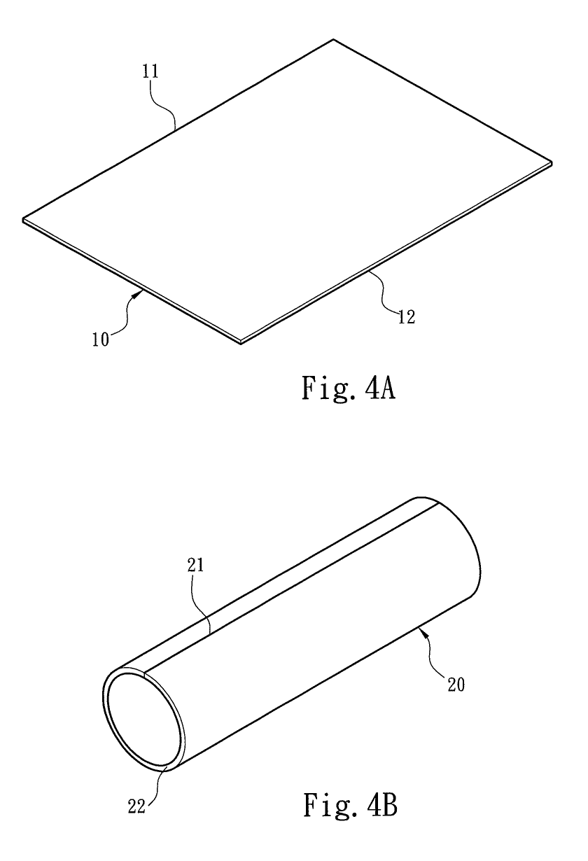

Referring to FIGS. 4A and 4B, in one embodiment of fabricating a sleeve for a trampoline, first, provide a plate 10 which has a first lateral edge 11 and a second lateral edge 12; bend the plate 10 through a fabrication process and machine, such as a plate folding machine, punch, plate bending machine or the like to form the plate 10 in a circular sleeve 20 shape that has a coupling seam 21 formed between the first lateral edge 11 and second lateral edge 12; bond the first lateral edge 11 and second lateral edge 12 to form the sleeve 20 through a bonding process such as soldering, brazing, arc welding, laser welding or diffusion bonding or the like depending on material characteristics of the plate 10.

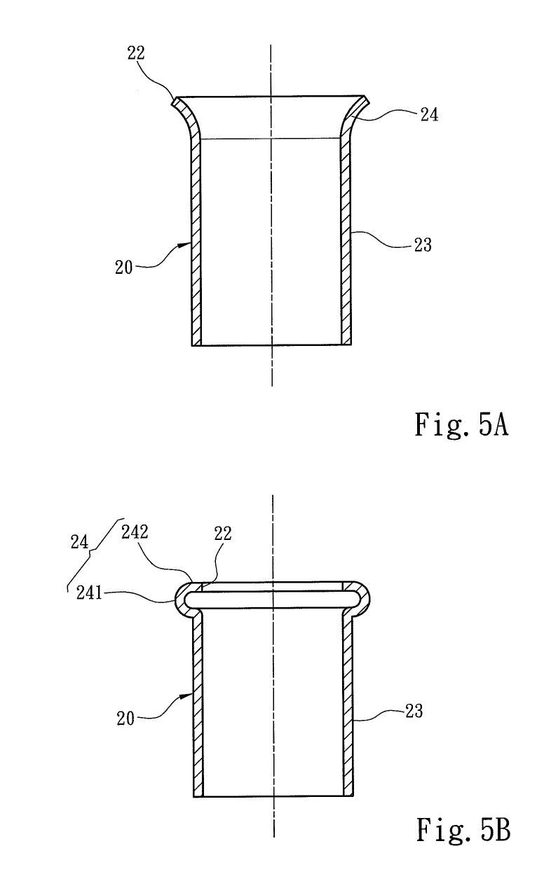

Refer to FIGS. 5A and 5B for one embodiment of fabricating sleeves for trampolines. The sleeve 20 has an opening 22 to be expanded to make the sleeve 20 include a body 23 and an expanded opening section 24 extended from the body 23. The expanded opening section 24 is formed at a diameter greater than that of the body 23. Expanding the opening can be accomplished by a punching process through a punch or an opening expanding machine. In this embodiment, the diameter of the expanded opening section 24 gradually expands along the axial direction of the sleeve 20. According to the fabrication equipment, the expanded opening section 24 may be formed in a cylindrical or conical shape. Then a compressive force is applied to the expanded opening section 24 to make the expanded opening section 24 to form an outer expanded portion 241 and an inner folding portion 242 shown in FIG. 5B. The outer expanded portion 241 is connected to the body 23 while the inner folding portion 242 is bent towards the interior of the sleeve 20 so that the inner wall of the sleeve 20 forms an annular groove. Moreover, the inner folding portion 242 is formed at an inner diameter smaller than the outer diameter of the outer expanded portion 241. The diameter of the inner folding portion 242 is gradually shrunk along the axial direction of the sleeve 20. In this embodiment, the opening expansion means and compressive force applying process can be performed on the same punch.

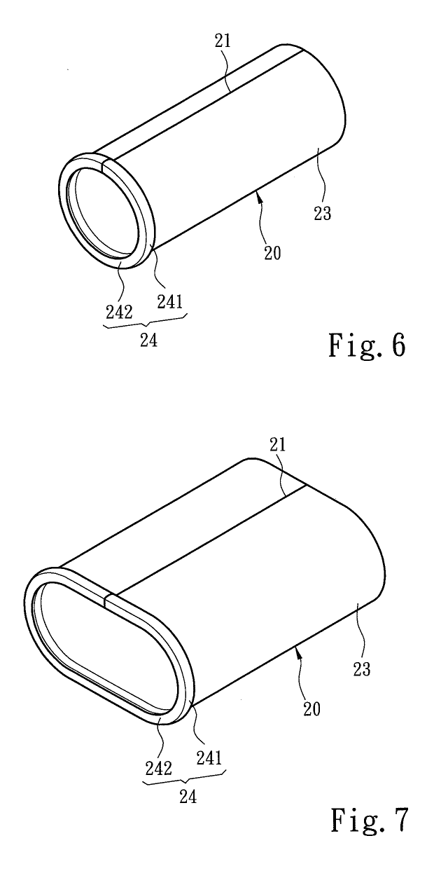

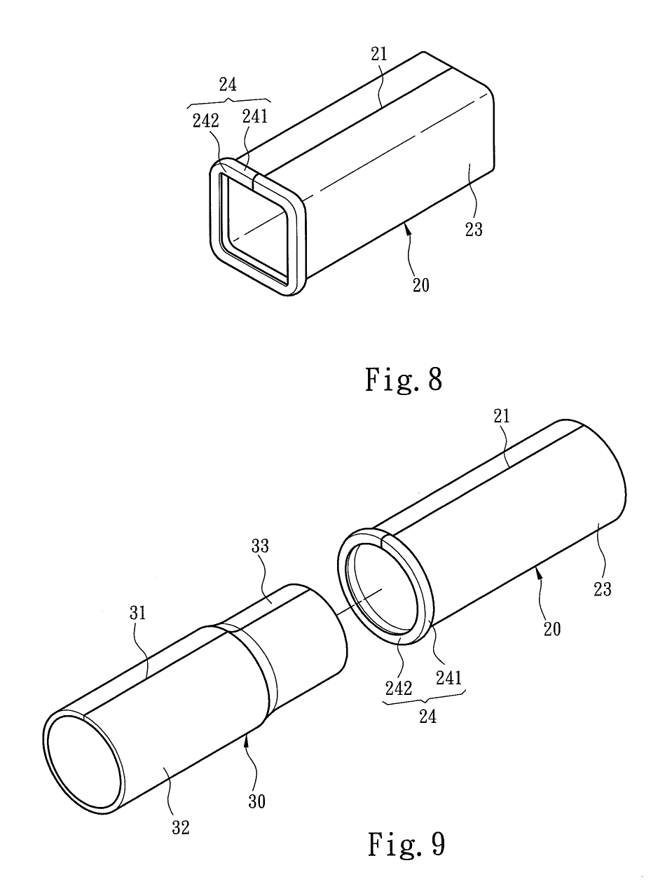

The sleeve 20 of the invention can be formed in varying profiles. FIG. 6 shows an embodiment of the sleeve 20 formed in a circular shape. FIG. 7 shows another embodiment of the sleeve 20 containing an upper plane and a lower plane in parallel, and left and right arched surfaces interposed between the upper and lower planes. Such a tubular structure can withstand greater compressive strength. The sleeve 20 may also be formed in a square shape as shown in FIG. 8.

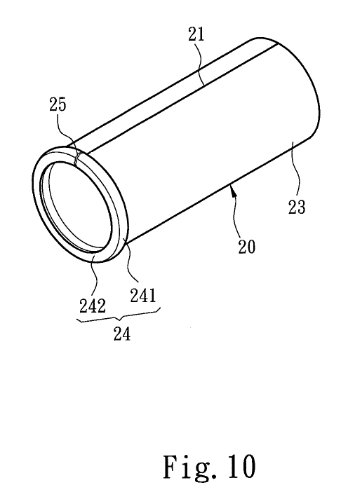

After the fabrication process of the sleeve 20 is finished, the coupling state of the coupling seam 21 in the outer expanded portion 241 and inner folding portion 242 can be inspected visually to determine whether the first lateral edge 11 and second lateral edge 12 are tightly bonded, and defects of the coupling seam 21 can also be detected visually through naked eyes, or through an image capturing device by capturing the image of the coupling seam 21, then operators can determine whether defects existed on the coupling seam 21 by examining the image. In practice, if no defect is seen on the coupling seam 21, the sleeve 20 can be judged acceptable for assembly in the following process as shown in FIG. 9 showing the sleeve and a connection tube in a coupled condition. In the event that a defect is detected on the coupling seam 21, referring to FIG. 10, a defect 25 is formed on the coupling seam 21 in the outer expanded portion 241 and inner folding portion 242, the sleeve 20 is judged unacceptable and has to be discarded or the bonding process of the sleeve 20 has to be performed anew.

Referring to FIG. 9 for assembly of the trampoline, after the sleeve 20 has judged acceptable through the visual inspection means, it can be coupled with a connection tube 30. In this embodiment, the connection tube 30 is fabricated through a process similar to the sleeve 20. The connection tube 30 also has a coupling seam 31, a body 32 and a coupling section 33 extended from the body 32. The coupling section 33 is formed at a diameter smaller than the body 32. During assembly, the sleeve 20 and connection tube 30 can be coupled in a compact manner. The structure formed by the outer expanded portion 241 and inner folding portion 242 can prevent damage of the coupling seam 21 when the sleeve 20 and connection tube 30 are collided with each or receive direct external impact. Moreover, according to actual requirements, the connection tube 30 may select a tube at a diameter between the outer and inner diameters of the body 23 without forming the coupling section 33 by fabrication.

As a conclusion, the method of fabricating sleeves for trampolines of the invention mainly aims to expand the opening of the sleeve and bend the opening before assembly of the sleeve and connection tube. Defects on the coupling seam can grow to a size visible by naked eyes. Hence operators can easily and visually detect defected products or acceptable products. On production lines, workers can instantly identify defected products through a simple fabrication process without sending the sleeves to other inspection equipment to do inspection before conveying to the following process. Thus assembly time of the trampoline can be reduced and production cost also is lower, and productivity can be enhanced. The outer expanded portion and inner folding portion also increase the structural strength after the sleeve and connection tube are coupled together.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method of fabricating sleeves for trampolines that includes a plurality of sleeves coupled to form a frame of a trampoline, comprising steps of:
bending a plate which includes a first lateral edge and a second lateral edge facing each other to form a coupling seam which is bonded through a bonding process to form a sleeve;
expanding an opening of the sleeve through an opening expansion means so that the sleeve includes a body and an expanded opening section extended from the body and formed at a diameter greater than the body;
applying a compressive force to the expanded opening section to form an outer expanded portion connected to the body and an inner folding portion bending inwards; and
inspecting visually coupling state of the coupling seam in the outer expanded portion and the inner folding portion to determine whether the first lateral edge and second lateral edge are bonded tightly.

2. The method of claim 1, wherein the opening expansion means is performed through a punching process to form the expanded opening section.

3. The method of claim 1, wherein the diameter of the expanded opening section gradually enlarges in the axial direction of the sleeve.

4. The method of claim 1, wherein the inner folding portion is formed at a diameter gradually shrunk in the axial direction of the sleeve.

5. The method of claim 1, wherein the inner folding portion is formed at an inner diameter smaller than an outer diameter of the outer expanded portion.

6. The method of claim 1, wherein inspecting visually the coupling seam inspects through naked eyes whether defects are existed on the coupling seam.

7. The method of claim 1, wherein inspecting visually the coupling seam is performed by getting an image of the coupling seam through image capturing equipment to inspect whether defects are existed on the coupling seam.

8. The method of claim 1, wherein the sleeve is formed in a circular shape.

9. The method of claim 1, wherein the sleeve is formed in a square shape.

10. The method of claim 1, wherein the sleeve is formed in a tubular structure which includes an upper plane and a lower plane parallel with each other and a left arched surface and a right arched surface interposed between the upper and lower planes.
